(19) United States
(12) Patent Application Publication
(10) Pub. No.: US 2010/0327069 A1
(43) Pub. Date: Dec. 30, 2010

(54) GEOTHERMAL HVAC SYSTEM FOR MODULAR BUILDINGS

(75) Inventor: Julius Poston, Panama City, FL (US)

Correspondence Address: MCGUIREWOODS, LLP, 1750 TYSONS BLVD, SUITE 1800, MCLEAN, VA, 22102, US

(73) Assignee: STALWART BUILT HOMES, PANAMA CITY, FL (US)

(21) Appl. No.: 12/823,836

(22) Filed: Jun. 25, 2010

Related U.S. Application Data
(60) Provisional application No. 61/220,403, filed on Jun. 25, 2009.

(51) Int. Cl. F24F 7/00; F24J 3/08; B23P 11/00

(52) U.S. Cl. 236/49.1; 165/45; 29/428

(57) ABSTRACT

A method, a system and a device for providing a geothermal HVAC system that is assembled and installed in a modular section prior to transport to a building site location. The system includes a modular section that is configured to be transported to a building site location and combined with other modules (or modular sections) to create a modular building.

### CROSS REFERENCE TO PRIOR APPLICATIONS

This application claims priority and the benefit thereof from U.S. Provisional Application No. 61/220,403, filed Jun. 25, 2009, titled “Geothermical HVAC System for Modular Buildings,” the entirety of which is hereby incorporated herein by reference.

### FIELD OF THE DISCLOSURE

The disclosure relates to a method, a system and a device for geothermal conditioning of modular buildings. More particularly, the disclosure relates to a method, a system and a device for geothermal cooling and/or heating a modular building, including a multilevel modular building.

### BACKGROUND OF THE DISCLOSURE

In response to, among other things, concern for the environment and rising costs of heating and/or cooling buildings, geothermal heating and air conditioning of buildings is growing in popularity. For example, geothermal heating and air conditioning systems are becoming common place in many modular homes. However, the work for providing geothermal heating and air conditioning to modular homes is done onsite, including assembly and connection of all of the various components found in a typical geothermal heating and air condition system.

An unfulfilled need exists for a method, a system and a device for providing preassembled geothermal heating, ventilating and air condition (HVAC) systems, which are installed at a modular installation (such as, for example, a factory, a plant, or the like) and provided as an integral part of a module of a modular building.

### SUMMARY OF THE DISCLOSURE

According to an aspect of the disclosure, a method, a system and a device are provided for providing a geothermal HVAC system that is assembled and installed in a modular section prior to transport to a building site location. The system may include a modular section that is configured to be transported to a building site location and combined with other modules (or modular sections) to create a modular building.

According to an aspect of the disclosure, a modular section is disclose that comprises a pre-installed geothermal HVAC system which is configured to be assembled with one or more other modular sections to form a building structure. The modular section comprises: an outdoor air duct that is configured to receive outdoor air from outside the building; a return air duct that is configured to receive return air from one or more spaces in the building; an air supply duct that is configured to supply air to the one or more spaces in the building; and a geothermal HVAC unit that is preinstalled and substantially ready to use upon assembly of the modular section with the one or more other modular sections. The geothermal HVAC unit may comprise: a flow center that controls flow of a fluid to or from a ground heat exchanger; a geothermal earth coupled unit that controllably transfers heat from or to the fluid; an outdoor air intake that receives the outdoor air from outside the building and supplies the outdoor air to the geothermal earth coupled unit through the outdoor air duct; a heat recovery pump that heats or cools at least one of the return air and the outdoor air; a filter that filters the return air or the outdoor air; a dehumidifier that controls moisture levels in the return air or the outdoor air; a water heater that heats water received from an external water supply; or a thermostat that controls a temperature of air in the one or more spaces in the building.

According to a further aspect of the disclosure, a method is disclosed for fabricating at a manufacturing facility a modular section comprising a geothermal HVAC system that is substantially ready to use, wherein the modular section is configured to be assembled with one or more other modular sections to form a building structure. The method comprises: installing a geothermal HVAC unit in a mechanical room of the modular section; installing an outdoor air duct that is configured to receive outdoor air from outside the modular section; installing a return air duct that is configured to receive return air from one or more spaces in the building; and installing an air supply duct that is configured to supply air to the one or more spaces in the building. The installing the geothermal HVAC unit may comprise: installing a flow center in the mechanical room; installing an earth coupled unit in the mechanical room; installing a heat recovery pump in the mechanical room; installing a dehumidifier in the mechanical room; installing a water heater in the mechanical room; installing a dehumidifier drain in the mechanical room; transporting the modular section to a building site; and/or assembling the modular section with the one or more other modular sections to form the building structure. The method may further comprise: connecting a flow center to a ground heat exchanger; and connecting a water heater to an external water supply.

According to a still further aspect of the disclosure, a method is provided for fabricating, at a manufacturing facility, a modular section comprising a geothermal HVAC system that is substantially ready to use, wherein the modular section is configured to be assembled with one or more other modular sections to form a building structure. The method comprises: installing a flow center in the modular section; installing an earth coupled unit in the modular section; installing a heat recovery pump in the modular section; installing a dehumidifier in the modular section; installing a water heater in the modular section; and installing a dehumidifier drain in the modular section.

Additional features, advantages, and embodiments of the disclosure may be set forth or apparent from consideration of the following detailed description and drawings. Moreover, it is noted that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1A shows an example of a modular multilevel building, according to principles of the disclosure;

FIG. 1B shows an example of an alternative modular multilevel building, according to principles of the disclosure;

FIG. 2 shows an example a module for the multilevel modular building shown in FIGS. 1A, 1B, according to principles of the disclosure; and

FIG. 3 shows an example of a process for installing, transporting and assembling a modular building, including a modular section having a geothermal HVAC system, according to principles of the disclosure.

The present disclosure is further described in the detailed description that follows.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

According to an aspect of the disclosure, a geothermal HVAC unit may be installed in, for example, a mechanical room on an assembly line of a manufacturing facility, such as, for example, a factory, a plant, or the like. In this regard, both the HVAC equipment and ductwork are installed in the manufacturing facility. Equipment may be selected according to, for example, ACCA Manual J calculations, and ductwork may be designed and routed around a modular marriage wall with a system of duct trunks connected by, for example, vertical flex duct chases. This eliminates the need for cutting through the marriage wall in between the lower modules. Ductwork crossovers may be provided in an attic space.

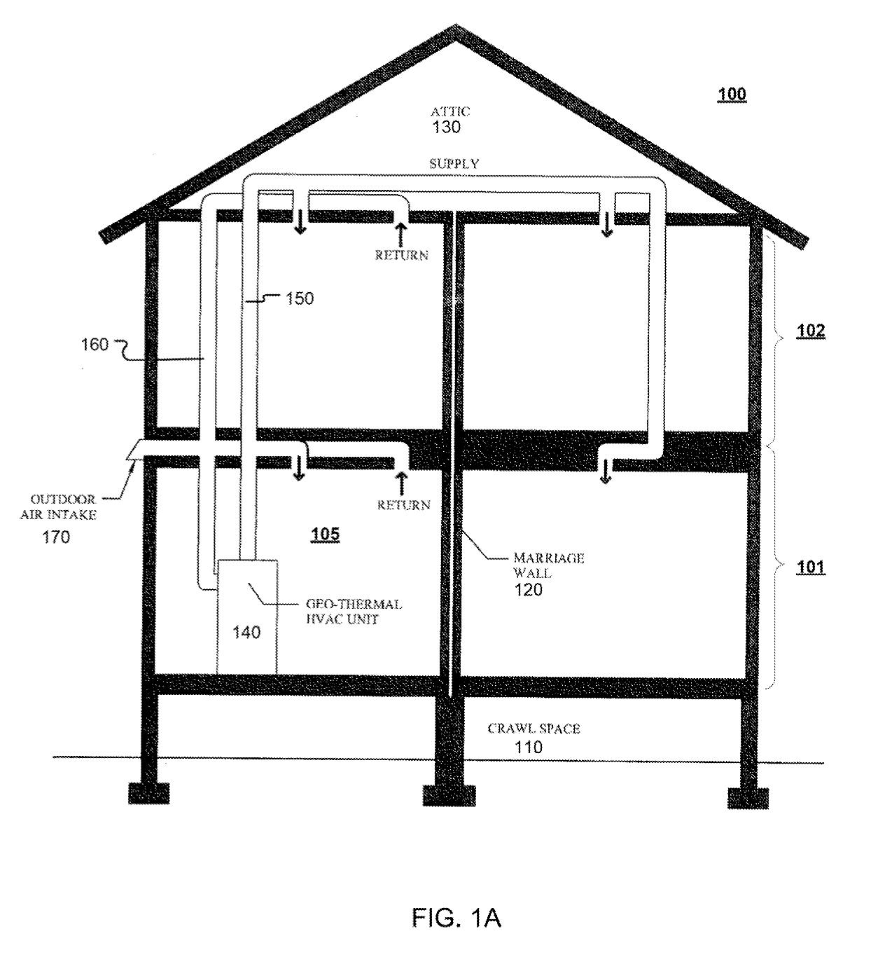

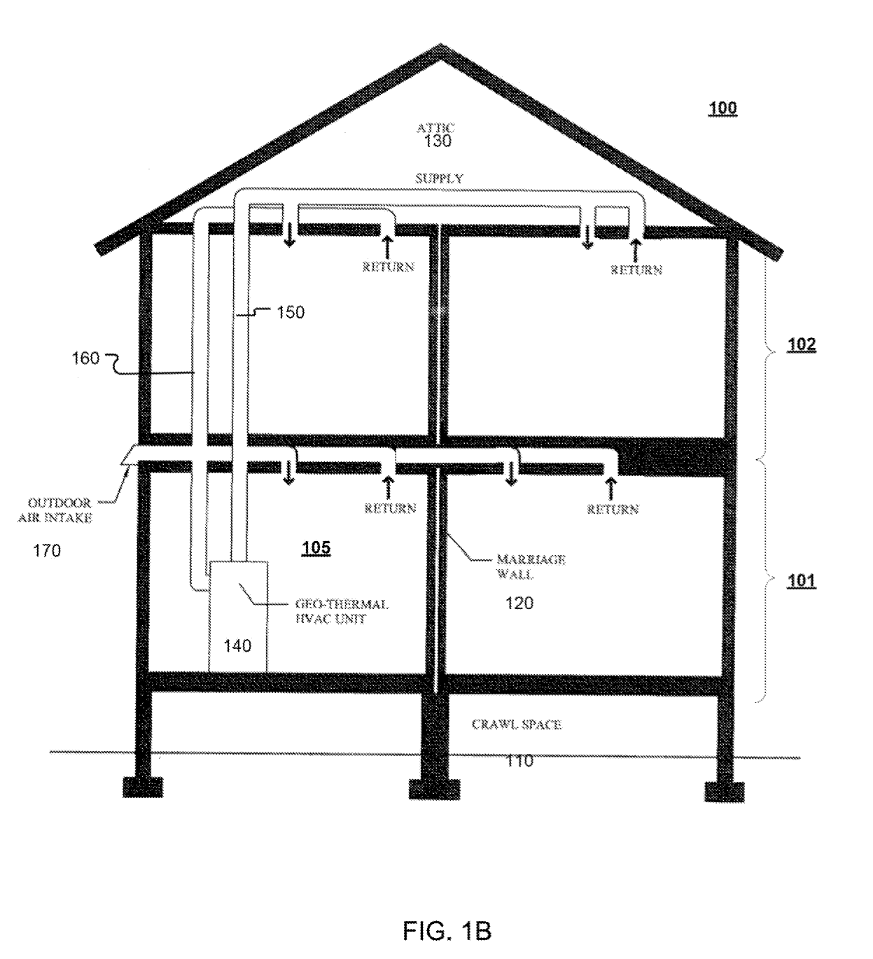

FIG. 1A shows an example of a modular multilevel building 100, according to principles of the disclosure. The building 100 may be assembled from a plurality of modules. The building 100 may comprise, for example, levels 101, 102, and an attic 130. The various modules of the building 100 may be transported to, for example, a building site location and assembled on to a foundation. The assembled building 100 may include a crawl space 110, a marriage wall 120, a geothermal HVAC unit 140, air supply ducts 150, air return ducts 160, and an outdoor air intake 170. The HVAC unit 140 is preassembled and installed at an installation facility, such as, for example, a factory, a plant, or the like, into a modular section 105 of the building 100, and transported and assembled into the building 100 as an integral part of the modular section 105. Furthermore, the supply ducts 150 and/or return ducts 160 may be assembled and installed into the various modules of the building 100 at the installation facility.

FIG. 1B shows an example of an alternative modular multilevel building 100, according to principles of the disclosure. As seen in FIG. 1B, the air supply/return ductwork 150, 160 may be placed as shown in the figure. It is noted that the air supply/return ductwork 150, 160 may be placed in various locations between the individual modules, as will be appreciated by those having ordinary skill in the art.

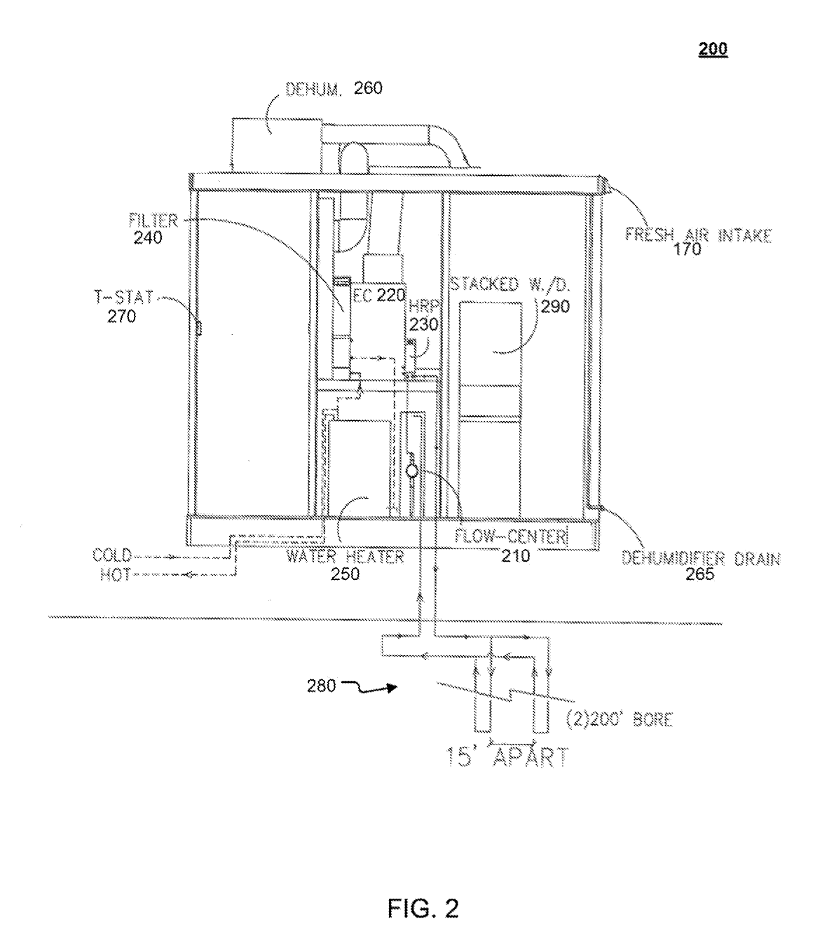

FIG. 2 shows an example of a modular section 200 that may be used in the modular section 105 of the multilevel modular building 100 shown in FIG. 1A, according to principles of the disclosure. The modular section 200 may be referred to as a “mechanical room.”

Referring to FIG. 2, the modular section (or mechanical room) 200 may include the fresh air intake 170, a flow center 210, a geothermal earth coupled (EC) unit 220, a heat recovery pump (HRP) 230, a filter 240, a water heater 250, a dehumidifier 260, a dehumidifier drain 265, and a thermostat (T-Stat) 270. The modular section 200 may further include a washer and/or drier 290. The modular section 200 may be completely assembled and installed at the installation facility, such that it may be readily and easily connected to, for example, plumbing, wiring, ducts, and a ground heat exchanger 280 at the time of assembly of the modular building at a building site location. For example, after delivery and assembly at the building site location, the modular section 200 may be connected to a ground heat exchanger 280, which may be, for example, buried proximate the modular building, installed at the bottom of a pond or lake, or the like, without limitation. The modular section 200 may be further connected to plumbing, wiring and/or ducts of other modular sections in the modular building.

According to an embodiment of the disclosure, the fresh air intake 170 may include, for example, an electronically controlled damper, or the like; the flow center 210 may include, for example, a flow regulator, a zone valve, or the like; the EC unit 220 may include, for example, a one-and-one-half (1½) ton geothermal unit, or the like; the HRP 230 may include, for example, a high efficiency, low energy consumption pump, or the like; the filter 240 may include, for example, a high efficiency filter, such as, e.g., F-100 media, or the like; the thermostat 270 may include, for example, a Honeywell Vision Pro thermostat, or the like; and the ground heat exchanger 280 may include, for example, a plurality of loops of conduits buried at about 200 feet at 15 feet apart. The fresh air intake 170 is configured to receive fresh air from outside of the building 100. The flow center controller 210 controls fluid flow to or from the ground heat exchanger 280, including one or more zones in the ground heat exchanger 280. The geothermal earth coupled (EC) unit 220 controllably transfers heat from or to the fluid flowing to or from the ground heat exchanger 280. The heat recovery pump (HRP) 230 heats (or cools) the building 100 as needed by conditioning the air circulated between the heat pump and the building 100 space (e.g. return air) and/or outdoor air received from the air intake 170. The filter 240 filters the air injected into the building 100 space via air supply ducts 150. The water heater 250 heats water received from an external water supply, such as, for example, a public water supply, a well, a tank, a reservoir, or the like, to provide hot water for use in the building 100. The dehumidifier 260 controls moisture levels in the air supplied into the building 100 space. The thermostat (T-Stat) 270 controls the temperature of the building 100 space.

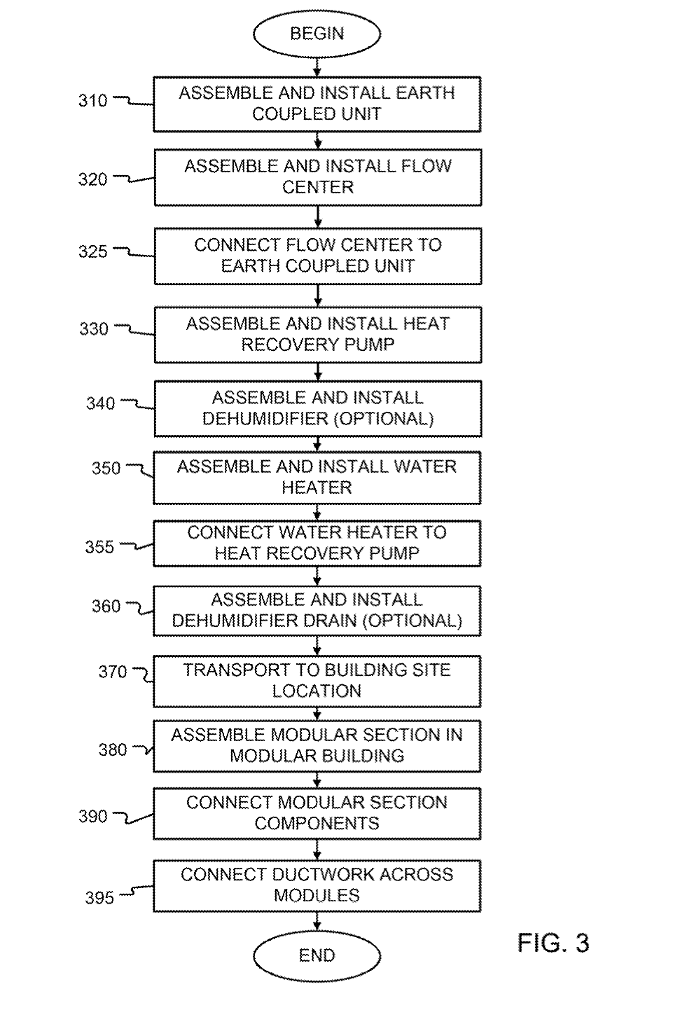

FIG. 3 shows an example of a process for installing, transporting and assembling a modular building, including a modular section having a geothermal HVAC system, according to principles of the disclosure.

Referring to FIGS. 2 and 3, the earth coupled unit 220 may be assembled and installed into the modular section 200 at the installation facility (Step 310). At substantially the same time (or at different times) the flow center 210 (Steps 320, 325), the HRP 230 (Step 330), the dehumidifier 260 (Step 340, which may be optional), the water heater 250 (Step 350), and the dehumidifier drain 265 (Step 360, which may be optional) may be assembled, installed and connected into the modular section 200 at the installation facility. It is noted that the Steps 310 through 360 may be carried out in any order, as understood by one of ordinary skill in the art, without departing from the scope or spirit of the disclosure. Moreover, some of the steps may be eliminated, such as, for example, the installation of the dehumidifier (Step 340) and dehumidifier drain (Step 360).

After the geothermal HVAC system is assembled and installed in the modular section 200, the modular section 200 may be transported to the building site (Step 370), where it may be assembled with the remaining modules into the modular building (Step 380). The geothermal HVAC unit may be substantially ready to use upon assembly of the modular section 200 with the other sections into the building 100. After (or during) assembly of the modular building, the modular section 200 components (such as, e.g., the flow center 210, the HRP 230, and the like) may be connected to the other modules and the ground heat exchange 280 (Step 390). Further, the ductwork may be connected across the modules (Step 395).

While the disclosure has been described in terms of exemplary embodiments, those skilled in the art will recognize that the disclosure can be practiced with modifications in the spirit and scope of the appended claims. These examples given above are merely illustrative and are not meant to be an exhaustive list of all possible designs, embodiments, applications or modifications of the disclosure.

For example, modular building may be constructed from multiple modular sections that comprise a geothermal HVAC unit. For instance, different HVAC systems may be provided for each level of the building.

What is claimed is:

1. A modular section comprising a pre-installed geothermal HVAC system that is configured to be assembled with one or more other modular sections to form a building structure, the modular section comprising:
an outdoor air duct that is configured to receive outdoor air from outside the building;
a return air duct that is configured to receive return air from one or more spaces in the building;
an air supply duct that is configured to supply air to the one or more spaces in the building; and
a geothermal HVAC unit that is preinstalled and substantially ready to use upon assembly of the modular section with the one or more other modular sections.

2. The modular section according to claim 1, wherein the geothermal HVAC unit comprises:
a flow center that controls flow of a fluid to or from a ground heat exchanger.

3. The modular section according to claim 2, wherein the geothermal HVAC unit comprises:
a geothermal earth coupled unit that controllably transfers heat from or to the fluid.

4. The modular section according to claim 3, wherein the geothermal HVAC unit comprises:
an outdoor air intake that receives the outdoor air from outside the building and supplies the outdoor air to the geothermal earth coupled unit through the outdoor air duct.

5. The modular section according to claim 1, wherein the geothermal HVAC unit comprises:
a heat recovery pump that heats or cools at least one of the return air and the outdoor air.

6. The modular section according to claim 1, wherein the geothermal HVAC unit comprises:
a filter that filters the return air or the outdoor air.

7. The modular section according to claim 1, wherein the geothermal HVAC unit comprises:
a dehumidifier that controls moisture levels in the return air or the outdoor air.

8. The modular section according to claim 1, wherein the geothermal HVAC unit comprises:
a water heater that heats water received from an external water supply.

9. The modular section according to claim 1, wherein the geothermal HVAC unit comprises:
a thermostat that controls a temperature of air in the one or more spaces in the building.

10. A method for fabricating at a manufacturing facility a modular section comprising a geothermal HVAC system that is substantially ready to use, wherein the modular section is configured to be assembled with one or more other modular sections to form a building structure, the method comprising:
installing a geothermal HVAC unit in a mechanical room of the modular section;
installing an outdoor air duct that is configured to receive outdoor air from outside the modular section;
installing a return air duct that is configured to receive return air from one or more spaces in the building; and
installing an air supply duct that is configured to supply air to the one or more spaces in the building.

11. The method according to claim 10, wherein installing the geothermal HVAC unit comprises:
installing a flow center in the mechanical room.

12. The method according to claim 10, wherein installing the geothermal HVAC unit comprises:
installing an earth coupled unit in the mechanical room.

13. The method according to claim 10, wherein installing the geothermal HVAC unit comprises:
installing a heat recovery pump in the mechanical room.

14. The method according to claim 10, wherein installing the geothermal HVAC unit comprises:
installing a dehumidifier in the mechanical room.

15. The method according to claim 10, wherein installing the geothermal HVAC unit comprises:
installing a water heater in the mechanical room.

16. The method according to claim 15, wherein installing the geothermal HVAC unit further comprises:
installing a dehumidifier drain in the mechanical room.

17. The method according to claim 10, further comprising:
transporting the modular section to a building site.

18. The method according to claim 17, further comprising:
assembling the modular section with the one or more other modular sections to form the building structure.

19. The method according to claim 18, further comprising:
connecting a flow center to a ground heat exchanger; and
connecting a water heater to an external water supply.

20. A method for fabricating at a manufacturing facility a modular section comprising a geothermal HVAC system that is substantially ready to use, wherein the modular section is configured to be assembled with one or more other modular sections to form a building structure, the method comprising:
installing a flow center in the modular section;
installing an earth coupled unit in the modular section;
installing a heat recovery pump in the modular section;
installing a dehumidifier in the modular section;
installing a water heater in the modular section; and installing a dehumidifier drain in the modular section.
